(19) United States
(12) Patent Application Publication
(10) Pub. No.: US 2014/0297168 A1
(43) Pub. Date: Oct. 2, 2014

(54) METHOD OF OPTICALLY LOCATING AND GUIDING A VEHICLE RELATIVE TO AN AIRPORT

(71) Applicant: GE Aviation Systems LLC, (US)

(72) Inventors: Norman Leonard Ovens, Ada, MI (US); Michael Eric Figard, Rockford, MI (US)

(73) Assignee: GE Aviation Systems LLC, Grand Rapids, MI (US)

(21) Appl. No.: 13/850,617

(22) Filed: Mar. 26, 2013

(51) Int. Cl. G08G 5/06

(52) U.S. Cl. CPC G08G 5/065
USPC 701/120

(57) ABSTRACT

A method of optically locating and guiding a vehicle relative to an airport having standardized signage where the method includes generating an image of at least a portion of the airport from an optical sensor mounted on the vehicle, determining the location of the vehicle, and providing guidance for operation of the vehicle.

### BACKGROUND OF THE INVENTION

Any number of vehicles including aircraft, maintenance trucks, emergency vehicles, and luggage transporters traverse portions of an airport at any given time. On the ground, knowing the position of such vehicles aids in ensuring the vehicle is in the desired position and to avoid incidences such as collisions. Any number of the vehicles may inadvertently enter an area they were not cleared to enter. This may be a result of disorientation by an operator.

### BRIEF DESCRIPTION OF THE INVENTION

In one embodiment, the invention relates to a method of optically locating and guiding a vehicle relative to an airport having standardized signage including receiving route information defining a predetermined route within the airport, generating an image of at least a portion of the airport from an optical sensor mounted on the vehicle, identifying at least some of the standardized signage in the generated image by processing the generated image, determining the location of the vehicle based on the identified standardized signage, comparing the determined location to the route information, and providing guidance for operation of the vehicle such that the vehicle progresses from the determined location along the predetermined route.

### BRIEF DESCRIPTION OF THE DRAWINGS

In the drawings:

FIGS. 1-5 are schematic illustrations of exemplary airport signage.

FIG. 6 is a perspective view of a portion of an aircraft that may be capable of optically locating itself

FIG. 7 is a perspective view of a portion of a truck that may be capable of optically locating itself

FIG. 8 is a flow chart of an exemplary method of optically locating a vehicle.

FIG. 9 is an exemplary image that may be generated during optically locating and guiding a vehicle.

### DESCRIPTION OF EMBODIMENTS OF THE INVENTION

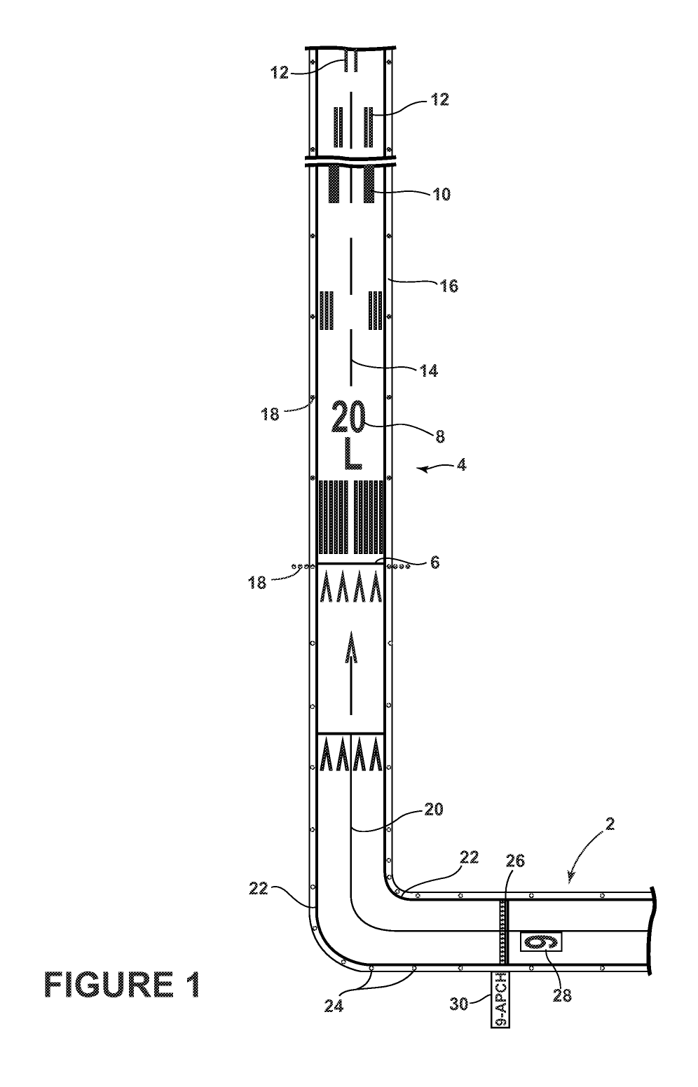

An initial explanation of an airport environment having standardized signage will be useful in understanding the inventive concepts. Airport signage, including signs, markings and lighting, are standardized by the International Civil Aviation Organization. FIGS. 1-5 illustrate a variety of airport standardized signage; additional information regarding standardized signage may be found at http://www.faa.gov.

Beginning with FIG. 1, a taxiway 2 aligned with a runway 4 is illustrated as well as runway threshold markings 6, runway designation markings 8, runway aiming point markings 10, runway touchdown zone markings 12, runway centerline markings 14, runway side stripe markings 16, runway lighting 18, taxiway markings including taxiway centerline 20, taxiway edge marking 22, taxiway lighting 24, holding position markings 26, holding position sign 28, and holding position sign 30.

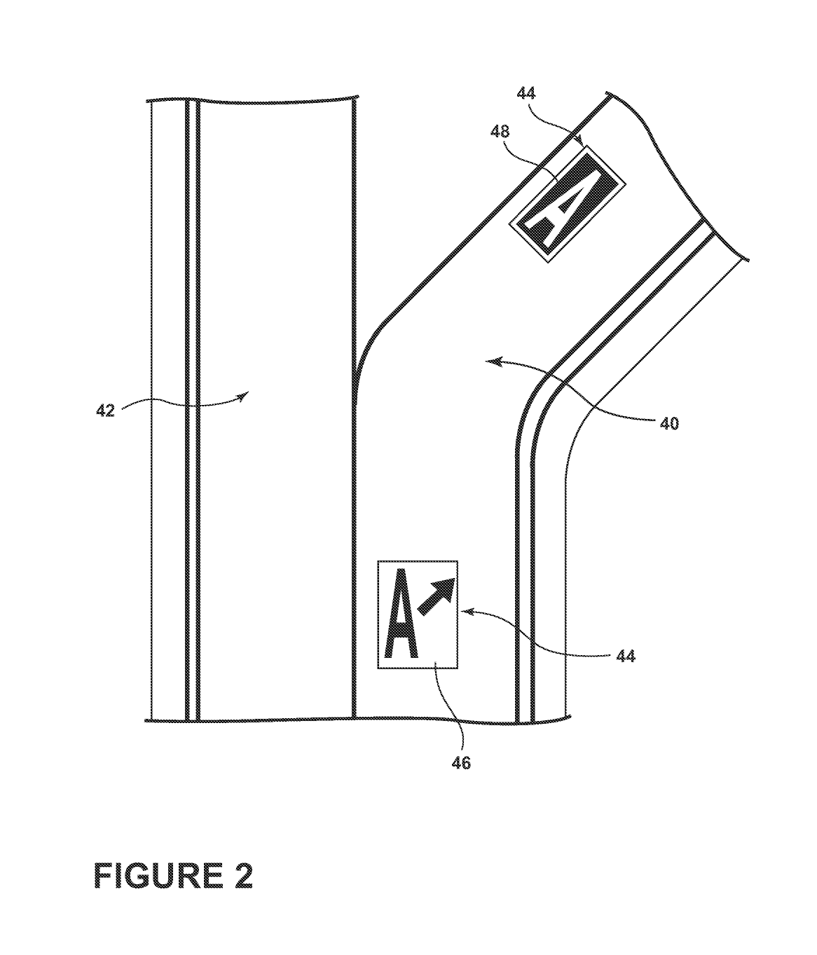

FIG. 2 illustrates taxiway 40 and taxiway 42 with geographic position markings 44 including a direction sign 46 and a location sign 48.

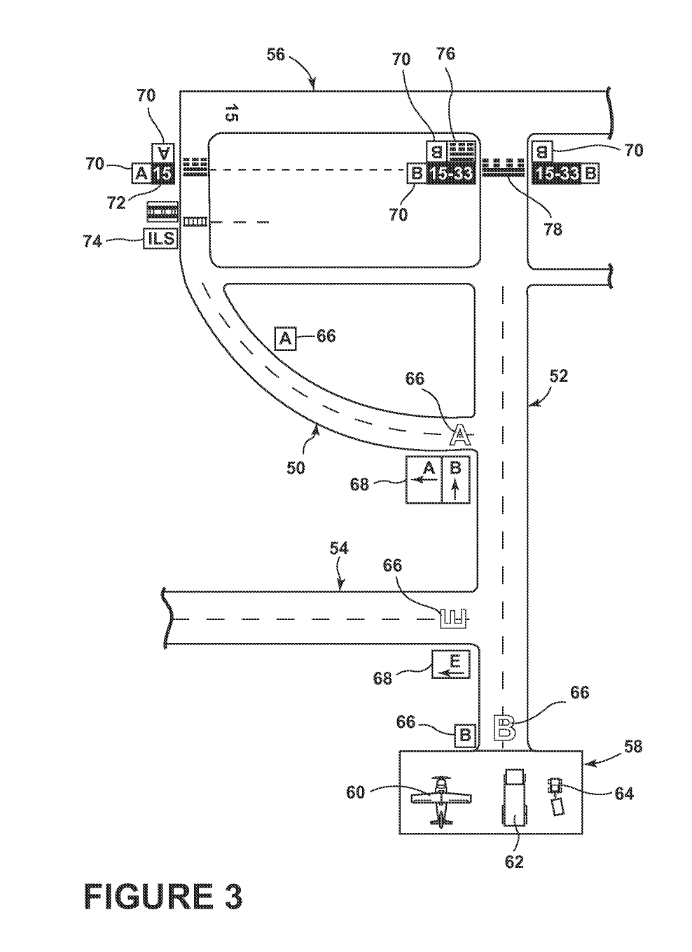

FIG. 3 illustrates a taxiway A at 50, a taxiway B at 52, a taxiway E at 54, a runway designated as 15 at 56 as well as an area 58 on which is located an aircraft 60, plow truck 62, and luggage cart 64 all of which may be capable of optically locating themselves per embodiments of the invention. Various location signs 66 including taxiway location markings have been illustrated as well as taxiway directional markings or direction signs 68. Such direction signs 68 identify the designation(s) of the intersecting taxiway(s) leading out of the intersection that a pilot would normally be expected to turn onto. Where appropriate, the direction signs 68 include arrow(s) indicating the direction of the turn. Direction signs 68 are normally located on the left prior to the intersection. Additional illustrated signage includes taxiway location signs 70 in combination with holding position signs 72 and 74, runway safety area markers 76 and 78.

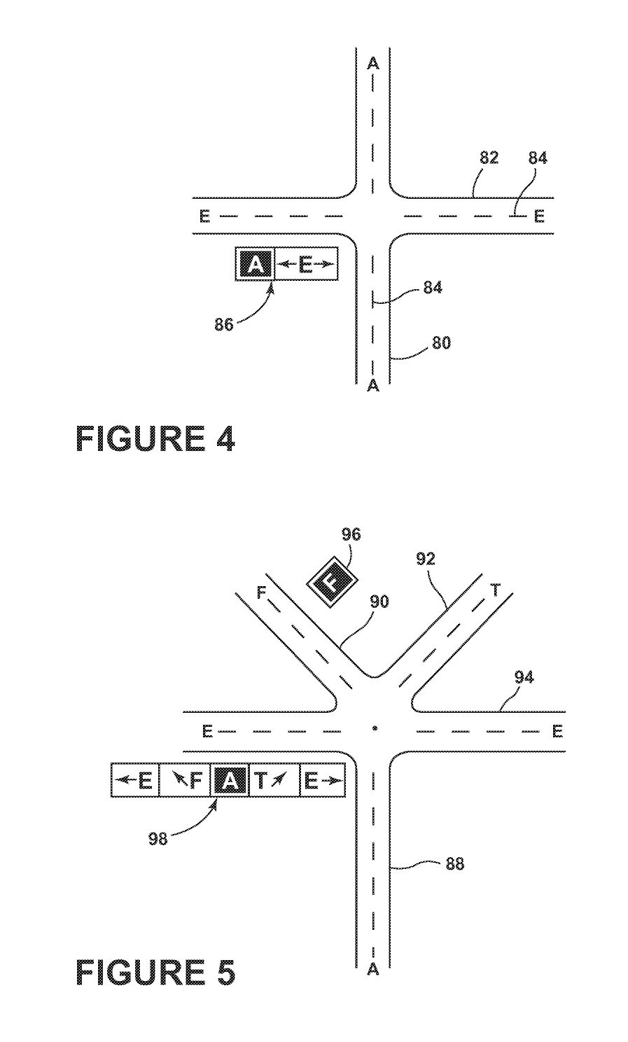

FIG. 4 illustrates a taxiway A at 80, a taxiway E at 82, both of which have been illustrated as including a centerline 84. The signage 86 includes both a location sign and a direction sign. When the intersection includes only one crossing taxiway, the direction sign may have two arrows associated with the crossing taxiway as illustrated. FIG. 5 illustrates a taxiway A at 88, a taxiway F at 90, a taxiway T at 92, and a taxiway E at 94, a location sign 96 and a destination and location sign 98. On the destination and location sign 98 the taxiway designations and their associated arrows are arranged clockwise starting from the first taxiway on the left. For a location sign located with the direction signs, the location sign is placed so that the designations for all turns to the left will be to the left of the location sign and the designations for continuing straight ahead or for all turns to the right would be located to the right of the location sign. It will be understood that FIGS. 1, 2, 3, 4, and 5 merely illustrate a portion of the standard signage at an airport and that additional or varying signage may be utilized.

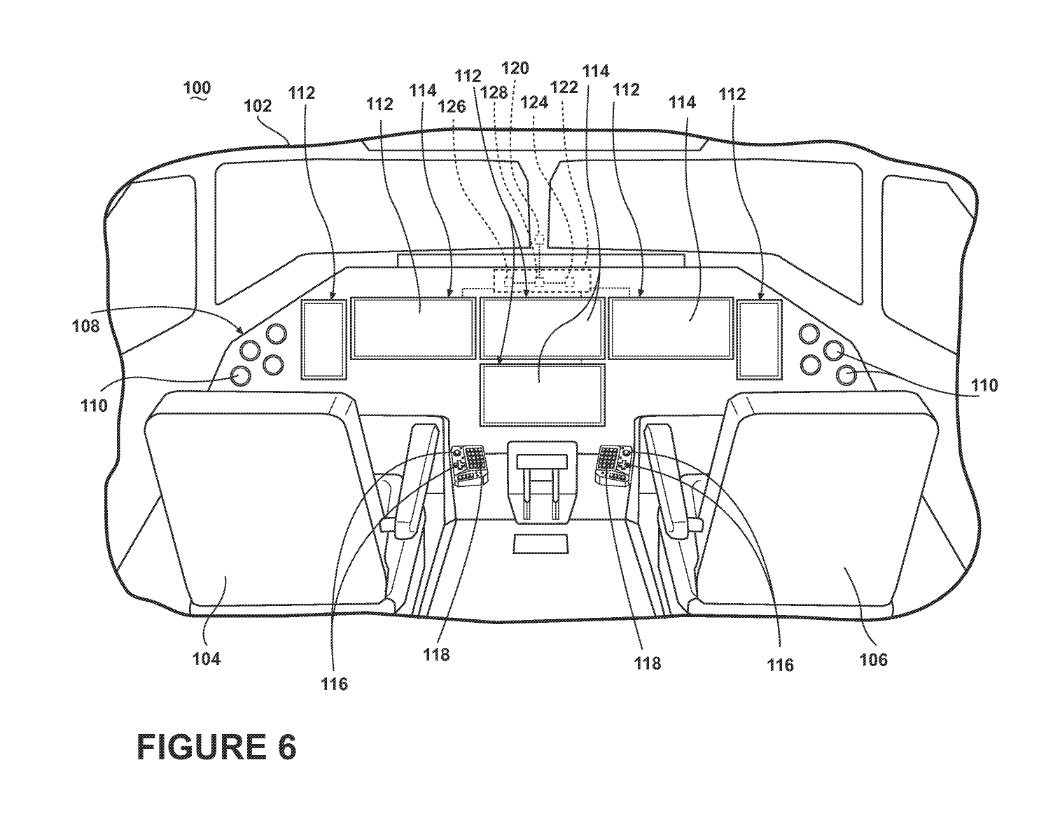

FIG. 6 illustrates an exemplary vehicle that may be capable of optically locating itself. In the illustrated example, the vehicle includes an aircraft 100 having a cockpit 102 where a first user (e.g., a pilot) may be present in a seat 104 at the left side of the cockpit 102 and another user (e.g., a co-pilot) may be present at the right side of the cockpit 102 in a seat 106. A flight deck 108 having various instruments 110 and multiple multifunction flight displays 112 may be located in front of the pilot and co-pilot and may provide the flight crew with information to aid in flying the aircraft 100. The flight displays 112 may include either primary flight displays or multi-function displays and may display a wide range of aircraft, flight, navigation, and other information used in the operation and control of the aircraft 100 including that the flight displays 112 may be electronic flight bag displays. The flight displays 112 may be capable of displaying color graphics and text to a user. The flight displays 112 may be laid out in any manner including having fewer or more displays and need not be coplanar or the same size. A touch screen display or touch screen surface 114 may be included in the flight display 112 and may be used by one or more flight crew members, including the pilot and co-pilot, to interact with the systems of the aircraft 100. It is contemplated that one or more cursor control devices 116 and one or more multifunction keyboards 118 may be included in the cockpit 102 and may also be used by one or more flight crew members to interact with the systems of the aircraft 100.

An optical sensor 120 may be mounted to the aircraft 100 and has been schematically illustrated as being located at an outside forward portion of the aircraft 100. It will be understood that the optical sensor 120 may be mounted anywhere on the aircraft 100, internal or external, and is preferably forward looking so that it may generate images of the environment located in front of the aircraft 100. By way of further example, multiple optical sensors 120 may be used including that wing-mounted sensors may be utilized. By way of non-limiting example, the optical sensor 120 may include a camera, which may be mounted on a forward portion of the aircraft 100 in a fixed location. Exemplary cameras include a CCD camera, a CMOS camera, a digital camera, a video camera, an infrared camera, or any other type of suitable camera for observing the external environment of the aircraft 100. In this manner, the optical sensor 120 may be capable of generating an image including at least one of a still image or a video image and outputting an image signal for same. The generated image may be in any suitable spectrum for the anticipated signage, including at least one of an infrared spectrum, visible light spectrum, and ultraviolet spectrum. It should be appreciated that the use of a camera is exemplary only and that other types of optical sensors 120 may be employed. Regardless of the type of optical sensor 120 used, it is contemplated that the optical sensor 120 may detect standardized signage, including markings such as markings painted on a runway in the environment in front of the aircraft 100. It is contemplated that the optical sensor 120 may provide any suitable type of image signal including images, video, etc. of at least a portion of environment in front of the aircraft 100.

A computer or controller 122 may be operably coupled to components of the aircraft 100 including the flight displays 112, touch screen surface 114, cursor control devices 116, multifunction keyboards 118, and optical sensor 120. The controller 122 may also be connected with other controllers (not shown) of the aircraft 100. The controller 122 may include memory 124 and a processor 126, which may be running any suitable programs. The memory 124 may include random access memory (RAM), read-only memory (ROM), flash memory, or one or more different types of portable electronic memory, such as discs, DVDs, CD-ROMs, etc., or any suitable combination of these types of memory. The controller 122 may also be connected with other controllers of the aircraft 100 over the aircrafts communication network. A computer searchable database of information may be stored in the memory 124 and accessible by the processor 126 or the controller 122 may be operably coupled to a database of information. For example, such a database may be stored on the same or alternative computer as the controller. It will be understood that the database may be any suitable database, including a single database having multiple sets of data, multiple discrete databases linked together, or even a simple table of data. For example, the database may include information related to standardized airport signage including standardized signs, standardized markings, and standardized lights. The controller 122 may also receive information from various sources including external memory, communication links such as a wireless communication link, and additional controllers or processors. For example, the aircraft 100 may receive a predetermined route for the aircraft 100 to traverse areas of the airport. Such a predetermined route may be input by the pilot or uploaded from an airline operations center. By way of non-limiting example, the predetermined route may include an airport taxi route from a gate at the airport to a runway that the aircraft is to takeoff on.

An image processing system 128 may utilize the database of standardized signage and an image processor. The image processing system 128 may be included in the aircraft 100 and may be operably coupled to the optical sensor 120 to receive the image signal and perform analysis on it. While the image processing system 128 is depicted as being a component of the controller 122, it is contemplated that the image processing system 128 could be a physically separate entity from controller 122. In the illustrated example, the controller 122 having the image processing system 128 may analyze the images signal from the optical sensor 120 without the utilization of a separate image processor. The image processing system 128 may be any suitable processing platform. Including that the image processing system 128 may be any combination of hardware and software that receives the image signal and processes or analyzes the image. For example, the image processing system 128 may include a software application that receives the image signal and processes it using object detection or recognition algorithms to detect and identify components of the environment in front of the aircraft 100.

By way of alternative example, the object recognition algorithm may be implemented in a set of computer executable instructions stored in the memory 124 of the controller 122 and a separate image processor component may not be required. For example, Optical Character Recognition (OCR) including application-oriented OCR or customized OCR software may be used to identify the standard signage. Additionally, object recognition such as computer vision-based object recognition may be used to recognize objects within the generated image.

The aircraft may be operated by the pilot to travel a predetermined route. For example, the aircraft may be taxied from the area 58 down the taxiway B at 52 to the runway 15 at 56. During such operation, the controller 122 may receive data from the optical sensor 120 from which the controller 122 and the image processing system 128 may determine information regarding the environment in front of the aircraft 100. By way of non-limiting example, the aircraft's location may be determined from the recognized signage in the image generated by the optical sensor 120. The controller 122 may access the memory 124 and the image processing system 128 may match the signage in the image with proper imagery data that may be stored in the memory 124. In this manner, the controller 122 may determine the location of the aircraft 100. The controller 122 may be configured to provide guidance to the pilot such that the pilot may operate the aircraft such that it continues to progress along the predetermined route. For example, if a taxiway location sign is identified, the controller 122 may determine the location of the aircraft 100 and may determine from its location what course of action should be taken to maintain the aircraft on its predetermined route. Many graphical and illustrative techniques may be used to indicate the location of the aircraft and provide guidance for operation of the aircraft. The guidance may be provided as any suitable indications using any suitable mechanism located in the cockpit 102.

While a commercial aircraft has been illustrated it is contemplated that embodiments of the invention may be used in any type of aircraft, for example, without limitation, fixed-wing, rotary-wing, rocket, personal aircraft, and military aircraft. It will be understood that the technology used in the general aviation aircraft may be the equivalent of a webcam and tablet computer with suitable software and in larger business and transport aircraft the technology used may include existing computer platforms, enhanced vision cameras, and integration with the Flight Management System for runway selection. It is also contemplated that the indication may be provided by the tablet computer. Embodiments of the invention may be used for non-autonomous and autonomous vehicles.

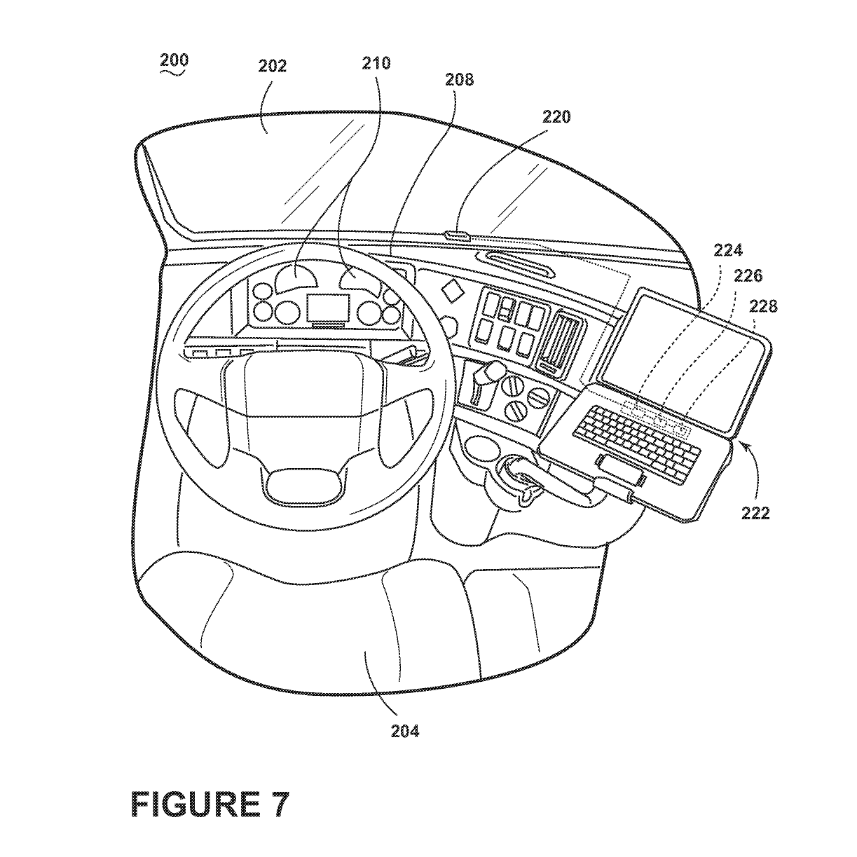

FIG. 7 illustrates an alternative exemplary vehicle that may be capable of optically locating itself. In the illustrated example, the vehicle includes a truck 200. The truck 200 includes many of the same features as the aircraft 100 previously described and therefore, like parts will be identified with like numerals increased by 100, with it being understood that the description of the like parts applies to this alternative embodiment, unless otherwise noted.

A cabin 202 where a user may be present in a seat 204 is included in the truck 200. A dashboard 208 having various instruments 210 may be located in front of the user and may provide the user with information to aid in driving the truck 200. As with the previous vehicle, the truck includes an optical sensor 220, which may be mounted to the truck 200, and has been schematically illustrated as being located at a forward portion of the truck 200. It will be understood that the optical sensor 220 may be mounted anywhere on the truck 200, internal or external, and is preferably forward looking so that it may generate images of the environment located in front of the truck 200. In this manner, the optical sensor 220 may be capable of generating an image including at least one of a still image or a video image and outputting an image signal for same. It is contemplated that the optical sensor 220 may provide any suitable type of image signal including images, video, etc. of at least a portion of environment in front of the truck 200.

A controller or computer 222 may be operably coupled to components of the truck 200 including the optical sensor 220. The computer 222 may include memory 224 and a processor 226, which may be running any suitable programs. A computer searchable database of information may be stored in the memory 224 and accessible by the processor 226 or the computer 222 may be operably coupled to a database of information that includes information related to standardized airport signage including standardized signs, standardized markings, and standardized lights. An image processing system may be included in the computer 222 and may be operably coupled to the optical sensor 220 to receive the image signal and perform analysis on it. Although the computer 222 has been illustrated as a laptop computer, any suitable computer 222 or controller may be used. It is contemplated that the computer 222 may include a suitable user interface 216 and user interface screen 218. The computer 222 may also include any suitable system for creating an aural or visual indication.

The truck 200 operates much the same way as the aircraft 100 including that during operation the computer 222 may receive data from the optical sensor 220 from which the computer 222 and the image processing system 228 may determine information regarding the environment in front of the truck 200. By way of non-limiting example, the truck's location may be determined from the recognized signage in the image generated by the optical sensor 220. The computer 222 may access the memory 224 and the image processing system 228 may match the signage in the image with proper imagery data that may be stored in the memory 224. In this manner, the computer 222 may determine the location of the truck 200. A predetermined route for the truck may be communicated to the computer or otherwise be stored on the computer 222. The computer 222 may compare the determined location of the truck 200 with the predetermined route and the computer 222 may provide indications including operational instructions regarding the same to the driver.

For example, if the truck 200 is meant to plow the taxiway B at 52 before plowing the runway 22 at 56, and then taxiway A at 50 (this may define its predetermined route), the computer 222 may determine the location of the truck 200 and may compare its location to the predetermined route and may provide directional guidance to the user to maintain the truck on the predetermined route. Many graphical and illustrative techniques may be used to indicate the location of the truck 200 and guidance to maintain the truck on the predetermined route and such guidance may appear on the user interface screen 218 or may aurally be communicated to the user.

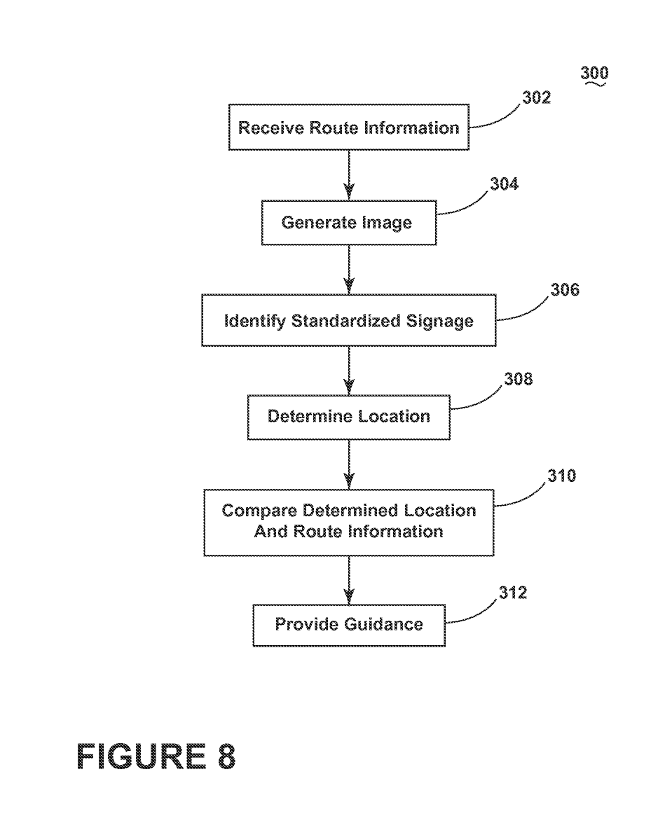

In this manner, it will be understood that any suitably equipped vehicle may optically locate itself relative to an airport having standardized signage and with respect to a predetermined route for the vehicle such that guidance may be provided for operation of the vehicle to make continued progress along the predetermined route. In accordance with an embodiment of the invention, FIG. 8 illustrates a method 300 of optically locating a vehicle relative to an airport having standardized signage.

The method 300 may begin with receiving route information defining a predetermined route within the airport at 302. The route information may include at least a destination for the vehicle. Alternatively, the predetermined route information may include the taxiways, runways, etc. that the vehicle is to travel. The predetermined route may be received in any suitable manner including that the predetermined route may be received from an airline operations center or other location or may be input by a user of the vehicle.

The method 300 may continue with generating an image of at least a portion of the airport at 304. This may be done using any suitable optical sensor including a camera mounted on the vehicle and may include generating an image a taxiway of the airport, a runway of the airport, and surrounding areas. At 306, at least some of the standardized signage in the generated image may be identified. This may be accomplished by processing the generated image on a computer aboard the vehicle. Identifying at least some of the standardized signage in the generated image may include identifying at least one of runway threshold markings, runway designation markings, runway aiming point markings, runway touchdown zone markings, runway centerline markings, runway side stripe markings, runway shoulder markings, taxiway location markings, taxiway directional markings, taxiway centerline markings, geographic position markings, and holding position markings.

At 308, the location of the vehicle may be determined based on the identified standardized signage. For example, the computer onboard the vehicle may use information regarding standard airport signage, markings and lighting to determine the position of the vehicle relative to the airport or using the standardized signage identified in the generated image. Determining the location may include determining a progress of the vehicle along the predetermined route. By way of non-limiting example, a detected taxiway directional marking may be compared with data regarding the predetermine route for the vehicle. It is contemplated that determining the location of the vehicle may include determining the distance from the vehicle to the identified standardized signage. A situational position of the vehicle may also be determined based on the identified standardized signage.

It is contemplated that multiple images may be generated and that the location of the vehicle may be determined based on the signage identified in the multiple images. It is further contemplated that more than one sensor may be used such that multiple images may be generated by the sensors and that the location of the vehicle may be determined based on the signage identified in the multiple images. The multiple images may better allow for depth to be determined aiding in the determination of the location of the vehicle. By way of example, object recognition software may determine the taxiway or runway the vehicle is currently on as well as approaching crossing intersections.

At 310, the location determined at 308 may be compared with the route information to aid in defining where the vehicle is compared to the predetermined route.

At 312, guidance for operation of the vehicle may be provided. The guidance may include directions or other information to aid in the vehicle progressing from the determined location along the predetermined route. By way of non-limiting example, providing guidance may include providing an indication or alert, within the vehicle, related to a control action for the vehicle. More specifically, in the case of the aircraft, the indication or alert may be provided to the flight crew within a cockpit of the vehicle. Appropriate visual and/or aural guidance may be presented to maintain the vehicle on its predetermined route. At least one of an audible and visual indication may be provided. A variety of suitable indications may be provided based on the determined location of the vehicle. For example, indications may include that the vehicle is approaching a taxiway or runway on the ground or crossing a taxiway or runway on the ground. A visual or aural indication may identify if the vehicle is to maintain its course or turn onto an intersecting taxiway or runway.

If it is determined at 310 that the vehicle has somehow deviated from its predetermined route an indication regarding the discrepancy between the determined location and the predetermined route may be provided. In such an instance the guidance provided at 312 may include guidance to return the vehicle to its predetermined route. Alternatively, the guidance may include guidance regarding a new or alternative route that is based on the previously received route information and the determined location of the vehicle.

It will be understood that the method of guiding the vehicle is flexible and that the method 300 illustrated is merely for illustrative purposes. For example, the sequence of steps depicted is for illustrative purposes only, and is not meant to limit the method 300 in any way as it is understood that the steps may proceed in a different logical order or additional or intervening steps may be included without detracting from the embodiments of the invention. For example, the method may include continuously generating the image at 304, continuously determining the location of the vehicle at 308, and continuously providing guidance based thereon at 312.

The camera image can also be supplemented with additional identifying features to highlight the detected signage to vehicle operators if the camera image is displayed to the operators. For example, the taxiway centerline marking may be identified and steering commands may be provided based thereon. Further, alerts may be provided if the vehicle is moved too far off the centerline of the taxiway.

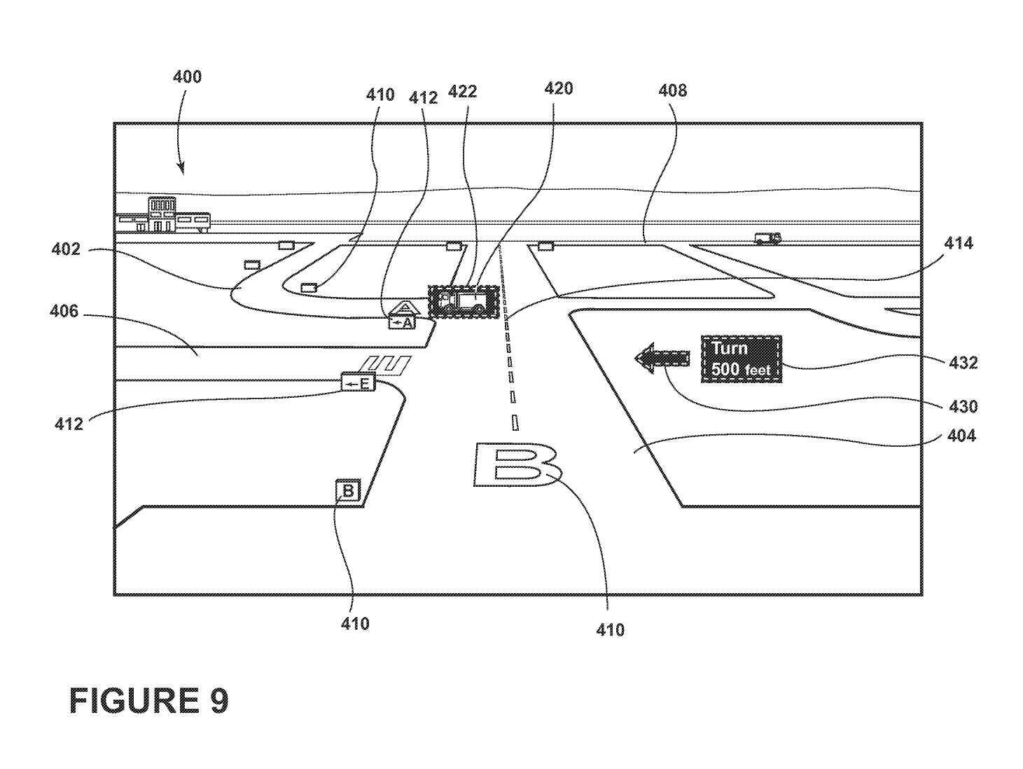

By way of non-limiting example, the method of optically locating the vehicle may include generating an image of portions of the airport. For example, FIG. 9 illustrates an image of a portion of an airport 400 including taxiway A at 402, taxiway B at 404, taxiway E at 406, runway at 408 that may be taken by a vehicle traveling along a predetermined route. The above described embodiments may identify at least some of the standardized signage including location signs 410, direction signs 412, and centerline markings 414.

It is contemplated that a distance the vehicle is from an approaching taxiway or runway may be determined from the identified signage. More specifically, the perspective of the signage in the generated image may be used to determine the distance the vehicle is from the approaching taxiway. An indication of the distance the vehicle is from the taxiway may then be provided within the vehicle along with any guidance to maintain the vehicle on its predetermined route such as guidance for turning the vehicle onto the approaching taxiway.

By way of additional non-limiting example, it is also contemplated that one or more hazards 420 may be identified in the generated image and that an alert of the identified hazard may be provided. For example, it is contemplated that indications may be given with respect to detected hazards on the runway such as vehicles or animals. In the illustrated example, a hazard 420 in the form of a truck is located on the taxiway B at 404 and an alert may be provided regarding same. For example, if the image is displayed to the operator of the vehicle, then the hazard 420 may be indicated with highlighting on the screen such as indicated at 422. If the vehicle is to travel from taxiway B at 404 to taxiway E at 406, then guidance such as an arrow at 430 may be provided and an indication of when to turn, for example in 500 feet as indicated at 432, may be provided.

Furthermore, the physical airport signage and markings could be supplemented with infrared or ultraviolet mechanisms to convey additional information to assist in detection and identification. More specifically, the infrared or ultraviolet mechanisms could be recognized if the optical sensor technology used can discern the infrared and ultraviolet objects. It is contemplated that such mechanisms may not be human readable letters or numbers and may include shapes or digital encoding. Furthermore, these mechanisms may not be the current standard symbology in the standardized signage and may instead by symbology developed for locating the vehicle. The optical sensor image can also be supplemented with additional identifying features to highlight the detected taxiway and runway components if the image is displayed to the operator of the vehicle. Further still, the indications provided to the operator may highlight or display the centerline of the taxiway or runway during low visibility operation. External systems may use the centerline identification to further augment ground steering methodologies used by those systems.

The above described embodiments provide a variety of benefits including that the proposed system is self-contained, may be used at any airport, and may be used with or without the existing advisory methodologies and provides an added safety layer to the existing layers of prevention measures. A technical effect is that the location of the vehicle may be determined from recognized signage and monitor progress along that route, advise of upcoming turns, approaching sensitive areas such as runways, including that alerts may be provided to the vehicle operator in an effort to prevent unapproved runway incursions and to ensure vehicle progresses along its predetermined route. The above described embodiments would not require prior knowledge of the airport topology, construction, or structure and does not require radar, positioning systems, or detailed airport map databases that require continual update. The system also identifies existing low visibility taxi lighting and signage to follow those indications and highlight the path to the vehicle operator.

Furthermore, it is contemplated that embodiments of the invention may be used with a vehicle in the form of an autonomous vehicle or an unmanned vehicle. In the case of an unmanned vehicle, an image may be generated from an optical sensor mounted on the unmanned vehicle. The identification of at least some of the standardized signage may be done either onboard the unmanned vehicle or at a ground station. If the processing is done at the ground station, such as for example a computer at the ground stations, it is contemplated that the unmanned vehicle and the ground station may have any suitable communication abilities so that the image signal may be provided to the ground station. Further, the providing the guidance for operation of the vehicle may include providing guidance to a user on the ground or may include providing operational instructions to the unmanned vehicle.

Further, it will be understood that the inventive embodiments may be capable of identifying any suitable additional signage. For example, while not illustrated or described runway guard lights and stop bar lights may also be included and utilized by the inventive embodiments. The runway guard lights help highlight the runway hold point and the stop bar lights are controlled by the control tower at some airports and are turned off when it is okay to cross or enter a runway.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of guiding a vehicle relative to an airport having standardized signage, including markings, the method comprising:
receiving route information defining a predetermined route within the airport;
generating an image of at least a portion of the airport from an optical sensor mounted on the vehicle;
identifying at least some of the standardized signage in the generated image by processing the generated image;
determining the location of the vehicle based on the identified standardized signage;
comparing the determined location to the route information; and
providing guidance for operation of the vehicle such that the vehicle progresses from the determined location along the predetermined route.

2. The method of claim 1 wherein:
the generating the image of at least a portion of the airport comprises generating an image of at least one of a taxiway and a runway of the airport;
the identifying the at least some of the standardized signage comprises identifying designation markings;
the determining the location comprises determining a progress of the vehicle along the predetermined route; and
providing guidance comprises providing an indication, within the vehicle, related to a control action for the vehicle.

3. The method of claim 1 wherein the generating the image comprises generating at least one of a still image or a video image.

4. The method of claim 1 wherein the generating the image comprises generating an image of at least one of an infrared spectrum, visible light spectrum, and ultraviolet spectrum.

5. The method of claim 1 wherein the generated image is processed on a computer aboard the vehicle.

6. The method of claim 5 wherein processing the generated image on a computer aboard the vehicle comprises applying an object recognition algorithm to the generated image.

7. The method of claim 6 wherein the object recognition algorithm is implemented in a set of computer executable instructions stored in a memory of the computer aboard the vehicle.

8. The method of claim 1 wherein the identifying the at least some of the standardized signage in the generated image comprises identifying at least one of runway threshold markings, runway designation markings, runway aiming point markings, runway touchdown zone markings, runway centerline markings, runway side stripe markings, runway shoulder markings, taxiway location markings, taxiway directional markings, taxiway markings, geographic position markings, and holding position markings.

9. The method of claim 1 wherein the route information contains at least a destination.

10. The method of claim 1 wherein the determining the progress of the vehicle comprises determining a distance from the vehicle to the identified standardized signage.

11. The method of claim 1 wherein the determining the progress of the vehicle comprises determination a situational position of the vehicle.

12. The method of claim 1 wherein the providing the guidance comprises providing an indication within the vehicle.

13. The method of claim 12 wherein the providing the indication comprises providing at least one of an audible and visual indication.

14. The method of claim 12 wherein the vehicle is an aircraft.

15. The method of claim 14 wherein the providing the indication comprises providing a visual display on a flight deck located within a cockpit of the aircraft.

16. The method of claim 12 wherein the providing the indication comprises providing an indication of a discrepancy between the determined location and the predetermined route.

17. The method of claim 16 wherein the guidance provided includes at least one of guidance to return the vehicle to the predetermined route and guidance regarding a new route.

18. The method of claim 1, further comprising identifying a hazard in the generated image.

19. The method of claim 18, further comprising providing an alert of the identified hazard.

20. The method of claim 1, further comprising continuously generating the image, determining the location, and providing guidance.
